(19) United States
(12) Patent Application Publication
(10) Pub. No.: US 2007/0214209 A1
(43) Pub. Date: Sep. 13, 2007

(54) PLATFORM AND METHOD FOR MOBILE SERVERS

(75) Inventor: Masahiro Maeda, Tokyo (JP)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/276,700

(22) Filed: Mar. 10, 2006

(51) Int. Cl. G06F 15/16

(52) U.S. Cl. 709/202; 709/227

(57) ABSTRACT

A method (500) and system (100) for facilitating access to a mobile server (MS) (107) can include a proxy server (111), a MS status database (MSSDB) 110, a search engine (109) and a SMS-push server (112) that can support transmission of information from the MS to wireless clients (105 or 106) coupled to a mobile network (102) or the Internet (104). The method can enable (502) the search and selection of mobile servers using status information among an availability, a location, or a time frame criteria. The method can enable (505) access to a selected MS via a proxy server, provide (507) streamed content to the client from the MS if the MS is currently available, and provide (508) cached content to the client previously stored from the MS on a storage medium (150) operatively coupled to the proxy server if the MS is currently offline.

### FIELD

This invention relates generally to communication systems and devices, and more particularly to a method and system of enhancing mobile server functionality.

### BACKGROUND

A server program such as an HTTP server or streaming server program can be operated on a mobile terminal and essentially operate as a mobile server. Since the battery life of a mobile server is limited, an operator of the mobile server might limit the online time of the mobile server in which case a client will receive an error message (e.g. 404 Server Not Found etc.) instead of the contents from the mobile server. With such an anticipated frequent occurrence of error messages, potential client users will likely stop accessing the mobile server. Furthermore, with the possibility of an unstable wireless link, the mobile server can also be expected to disconnect from a mobile network or Internet connection frequently whereupon the client user again sees error messages.

Additionally, Internet Protocol (IP) addressing is wasteful in several respects in the existing cellular packet network. Currently, an IP address is assigned to a mobile terminal while it is active, in other words, while communicating. In a mobile server environment, a mobile server connected to a cellular network needs to send packets periodically to avoid being disconnected by the network even when no clients are attempting to access it. Such periodic sending of packets is a waste of network resource as well as an unnecessary drain on battery life.

To find such mobile servers on a mobile network, a search engine can be a convenient way. Note, that existing search engines update their indexes infrequently. This infrequent updating is unsuitable for mobile servers since they often start and stop their services for various reasons as evidenced by the battery life and unstable wireless link issues described above. Existing search engines fail to account for the mobile server environment and for the time period that a server is working or providing content whether scheduled or unscheduled. Furthermore, existing search engines fail to consider the location of mobile servers.

### BRIEF DESCRIPTION OF THE DRAWINGS

The accompanying figures, where like reference numerals refer to identical or functionally similar elements throughout the separate views, together with the detailed description below, are incorporated in and form part of the specification, and serve to further illustrate the embodiments and explain various principles and advantages, in accordance with the present invention

FIG. 1 is a block diagram illustrating live streaming of content from a mobile server to client devices in a communication system in accordance with an embodiment of the present invention.

FIG. 2 is a more detailed block diagram illustrating components of the communication system in accordance with an embodiment of the present invention.

FIG. 3 is a flow diagram illustrating a data flow of data and content in the communication system in accordance with an embodiment of the present invention.

FIG. 4 is another flow diagram illustrating the flow of live content or cached content in the communication system in accordance with an embodiment of the present invention.

FIG. 5 is a flow chart illustrating a method of facilitating access to a mobile server in accordance with an embodiment of the present invention

FIG. 6 is a block diagram of a communication device in accordance with an embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE DRAWINGS

While the specification concludes with claims defining the features of embodiments of the invention that are regarded as novel, it is believed that the invention will be better understood from a consideration of the following description in conjunction with the figures, in which like reference numerals are carried forward.

Before describing in detail embodiments that are in accordance with the present invention, it should be observed that the embodiments reside primarily in combinations of method steps and apparatus components related to facilitating access to mobile servers. Accordingly, the apparatus components and method steps have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

In this document, relational terms such as first and second, top and bottom, and the like may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

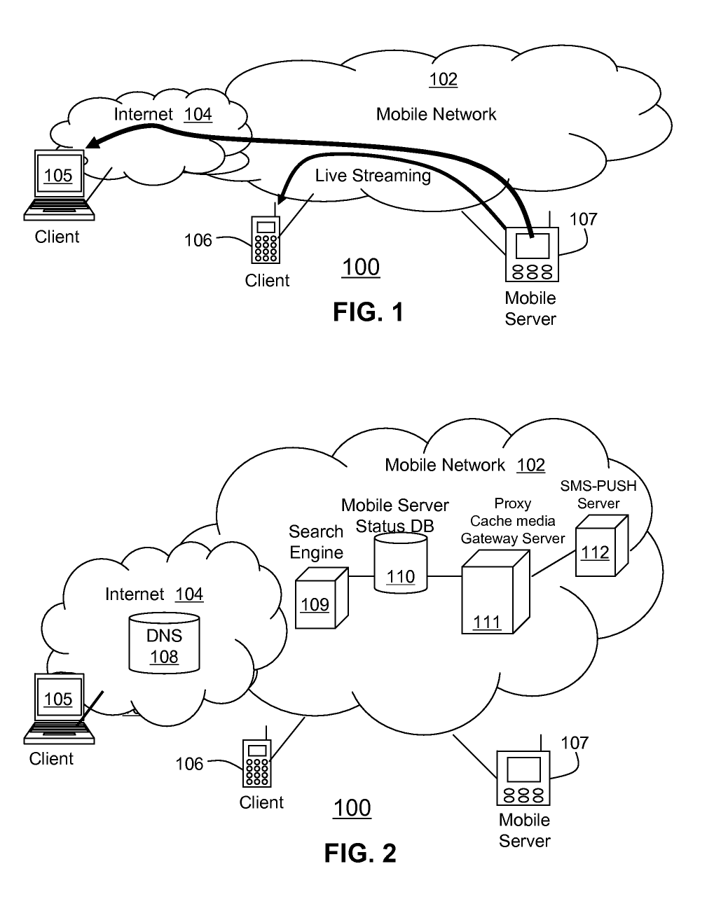

A method and apparatus for facilitating access to mobile servers can account for either the intermittency or mobility or both of such mobile servers. Since the services of mobile servers can be frequently intermittent, the time period when content is served can be considered when searching for a mobile server from clients. Likewise, since mobile servers can move and provide their service from anywhere, location can also be considered when searching for a mobile server from clients. Referring to FIG. 1, a communication system 100 having a mobile network 102 and a link to the Internet 104 is illustrated. A mobile server (MS) 107 can be linked to the mobile network 102 and provide service to one or more mobile or fixed nodes or clients 106 or 105.

Referring to FIG. 2, the communication system 100 can include a proxy server 111, a MS status database (MSSDB) 110, a search engine 109 and a SMS-push server 112 placed in the mobile network 102 that can support transmission of information from the MS 107 to wireless clients (106) as well as fixed client devices (105) coupled to the mobile network 102 or the Internet 104.

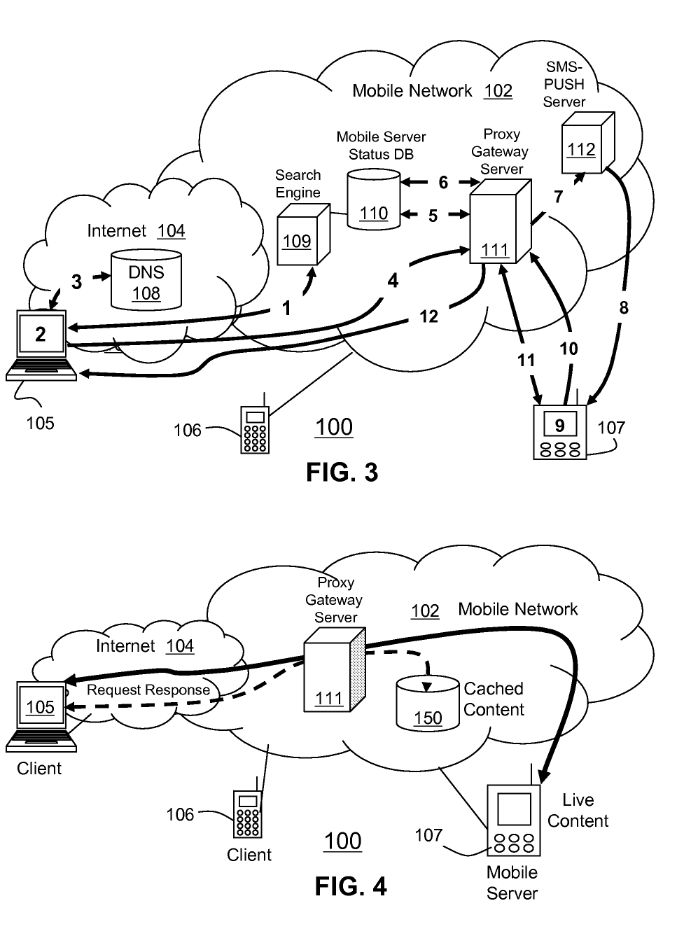

Further referring to FIG. 3, the procedure that a client (105) uses to access a MS (107) is detailed in a flow diagram illustrated by steps 1 through 12 among the components of system 100. A client 105 can access the search engine 109 at step 1 and can select at step 2 a MS 107 from the list that the search engine provided. The selection at step 2 can optionally cause a query to a domain name server (DNS) 108 and a response therefrom at step 3 before the client 105 sends a request message such as a HTTP request at step 4 via the proxy server. The proxy server 111 searches to determine if the MS 107 is already connected or in other words searches for an IP address corresponding to the requested URL from the mobile server status database (MSSDB) 110 at step 5. If the IP address is already registered, the proxy server can optionally look up the phone number for the MS 107 at step 6. If the IP address isn't registered, the proxy server 111 pages the MS 107 at steps 7 and 8 (with a request for an SMS trigger message) using the SMS-push server 112 and further lets the MS register its IP address and other information to the database 110 at step 10 after setting up the connection between the MS 107 and the mobile network 102 at step 9. When the proxy server 111 gets the IP address, the proxy server 111 can forward the request to the MS 107 at step 11 and relays the response from the MS 107 to the client 105 at step 12. The requests and responses can be in the form of HTTP requests and responses. When the proxy server 111 relays the contents from the MS 107, it can store the contents in a storage media such as a cache memory 150 as illustrated in FIG. 4. When the proxy server 111 gets a request to a disconnected or out-of-server MS, it sends cached contents instead of an error message. Note, although the flow is described in a particular order, it should be understood that embodiments within contemplation of the claims herein are not limited to such order or arrangement.

The proxy server 111 not only relays request/response messages, but it also triggers a page when the sought after or requested MS fails to obtain or retrieve an IP address to attempt to establish a connection with the MS. As discussed above, the proxy server 111 also provides cached contents according to the status of the requested MS. The proxy server can also serve to multicast the contents if the MS 107 gets multiple accesses from multiple clients. The MSSDB 110 can store the Uniform Resource Locator (URL), the IP address, and the telephone number (that can be used to send a paging SMS message), the server status (that shows whether the server program is running or not), connected media information, location information, scheduling information, and key words associated with the contents served. Other status information can further include connected medium information, and client access statistics such as a number of accesses, a number of users, and client addresses. Some or all of this information can be updated by the MS automatically. The search engine 109 can update its index frequently or in real time using the stored information in the MSSDB 110 and can provide a time and location based search feature. If a client accesses to a disconnected or out-of-service mobile server, the proxy server 111 can provide cached contents instead of an error message. This platform also can avoid sending packets periodically to keep its IP address. Instead, if the IP address of the mobile server is expired, the proxy server 111 can trigger a page when it gets a request from a client whereupon the mobile server 107 can obtain a new IP address to receive a request. Note, the mobile servers can also receive messages or control commands from clients. Control commands can be used to control a camera, microphone or other device operatively coupled to the mobile server. In the case of a camera, the control commands can be used to pan, zoom, or perform other adjustments for cameras or video devices.

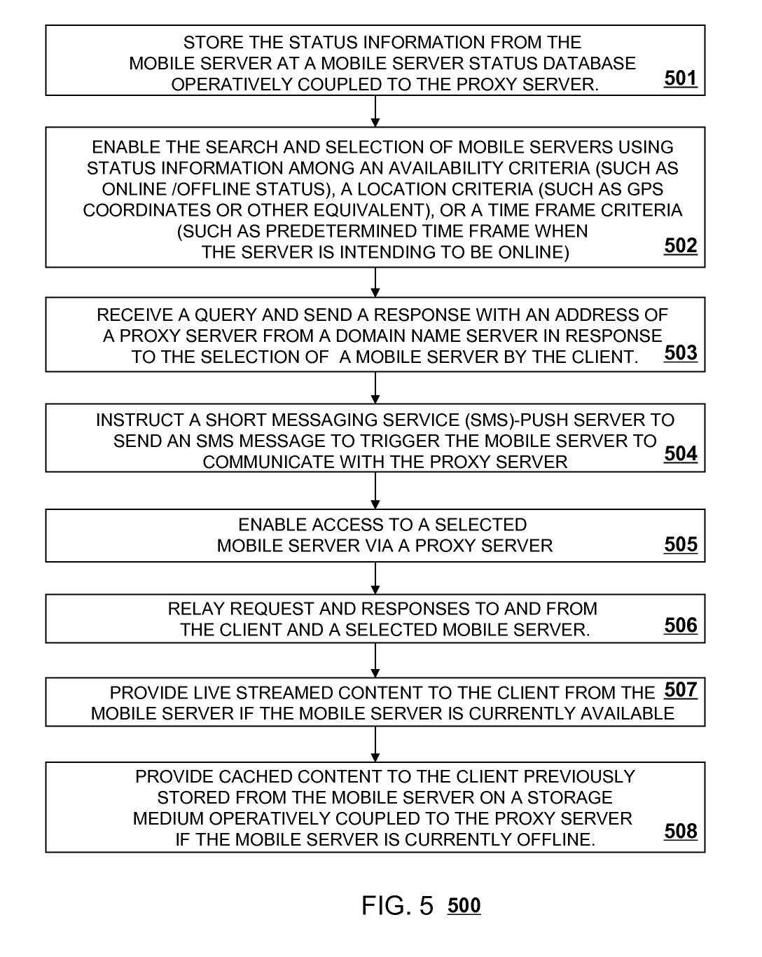

Referring to FIG. 5, a method 500 of facilitating access to a mobile server by a client is shown. The method 500 can store the status information from the mobile server at a mobile server status database operatively coupled to the proxy server at step 501. The mobile server status database further can store URLs, IP addresses, and telephone numbers for the mobile server as well as status information associated with such URLs, IP addresses and phone numbers. The method 500 can further include the step 502 of enabling the search and selection of mobile servers using status information among an availability, a location, or a time frame criteria. The availability criteria can include an online or offline status of a selected mobile server, the location criteria can include for example GPS position coordinates or other location equivalents provided by the selected mobile server to the proxy server, and the time frame criteria can be a past, present or future time period when the selected server was, is or will be online. At step 503, the method 500 can receive a query and send a response (with an address of a proxy server) from a domain name server in response to the selection of a mobile server by the client. The method 500 can further include the step 504 of instructing a short messaging service (SMS)-push server to send an SMS message to trigger the mobile server to communicate with the proxy server. The method 500 can further enable access to a selected mobile server via a proxy server at step 505, relay request and responses to and from the client and a selected mobile server at step 506, and provide live streamed content to the client from the mobile server if the mobile server is currently available at step 507. The method 500 can provide cached content to the client previously stored from the mobile server on a storage medium operatively coupled to the proxy server if the mobile server is currently offline at step 508.

The communication system 100 described above can resolve a number of issues present in existing mobile servers including avoiding the display of annoying error messages for mobile servers being out-of-service, avoidance of unnecessary packet transmissions, and a lack of additional status updates and information. Mobile servers become out-of-service due to battery constraints, purposeful user constraints (e.g., mobile server service scheduling), or unstable wireless (or wired) connections. In some instances, a mobile server can lose the connection to the network or cannot continue its service for some reason while a client is accessing contents on the server where the client receives an error message and can't understand what happened on the mobile server. In other instances, a mobile broadcasting service is not necessarily on. In any instance described above, the mobile service does not need to show an error message to clients while the mobile server is out-of-service.

With respect to inefficiency and unnecessary packet transmissions, a mobile server connected to a cellular network generally needs to send packets periodically to avoid being disconnected by the network, even if no client is accessing to it. The scheme described above triggered by a search of a mobile server can avoid such inefficiencies.

Since most search engines are focused on a wired environment, updates of search engine indexes are inadequate in terms of scope and frequency. Existing search engines fail to update their indexes to keep pace with frequent in-service/out-of-service changes of mobile servers. Existing search engines fail to assume that servers often change their service status. In terms of scope, existing search engines also fail to track whether a particular mobile server is broadcasting during a given schedule or period or from where the mobile server is broadcasting. Existing search engines fail to assume that sites move often and that physical location of the sites and time matter with respect to the content. The search engines contemplated herein can search mobile servers based on time to determine if a mobile server is broadcasting currently or during a certain period (whether in the future or in the past). Likewise, search engines contemplated herein can alternatively or optionally search mobile servers that are or were broadcasting at a certain place or location.

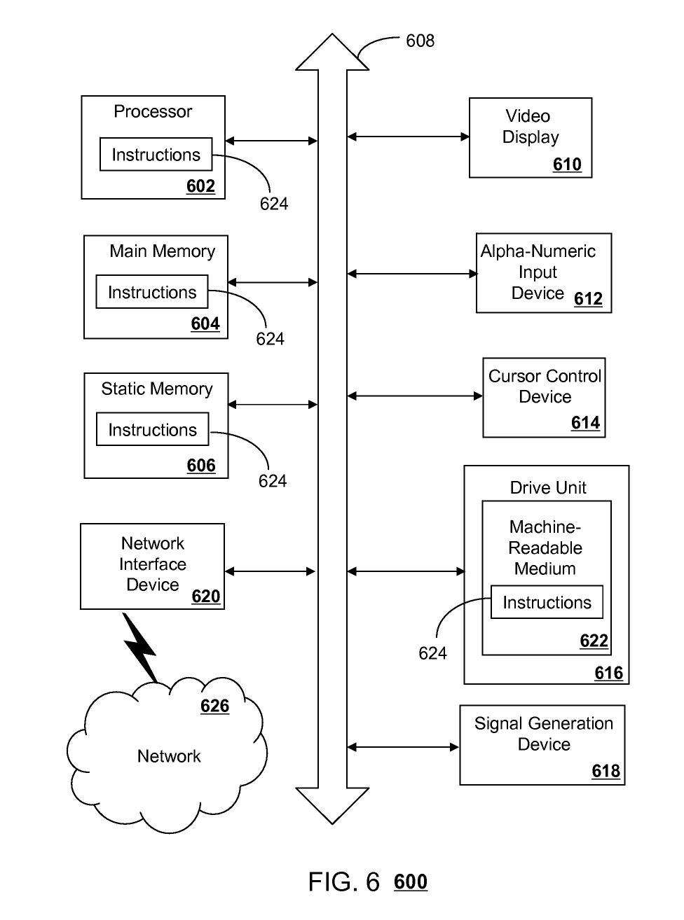

FIG. 6 depicts an exemplary diagrammatic representation of a machine in the form of a computer system 600 within which a set of instructions, when executed, may cause the machine to perform any one or more of the methodologies discussed above. In some embodiments, the machine operates as a standalone device. In some embodiments, the machine may be connected (e.g., using a network) to other machines. In a networked deployment, the machine may operate in the capacity of a server or a client user machine in server-client user network environment, or as a peer machine in a peer-to-peer (or distributed) network environment.

The machine may comprise a server computer, a client user computer, a personal computer (PC), a tablet PC, a laptop computer, a desktop computer, a control system, a network router, switch or bridge, or any machine capable of executing a set of instructions (sequential or otherwise) that specify actions to be taken by that machine, not to mention a mobile server. It will be understood that a device of the present disclosure includes broadly any electronic device that provides voice, video or data communication. Further, while a single machine is illustrated, the term “machine” shall also be taken to include any collection of machines that individually or jointly execute a set (or multiple sets) of instructions to perform any one or more of the methodologies discussed herein.

The computer system 600 can include a controller or processor 602 (e.g., a central processing unit (CPU), a graphics processing unit (GPU, or both), a main memory 604 and a static memory 606, which communicate with each other via a bus 608. The computer system 600 may further include a video display unit 610 (e.g., a liquid crystal display (LCD), a flat panel, a solid state display, or a cathode ray tube (CRT)). The computer system 600 may include an input device 612 (e.g., a keyboard), a cursor control device 614 (e.g., a mouse), a disk drive unit 616, a signal generation device 618 (e.g., a speaker or remote control) and a network interface device 620. Of course, in the embodiments disclosed, many of these items are optional.

The disk drive unit 616 may include a machine-readable medium 622 on which is stored one or more sets of instructions (e.g., software 624) embodying any one or more of the methodologies or functions described herein, including those methods illustrated above. The instructions 624 may also reside, completely or at least partially, within the main memory 604, the static memory 606, and/or within the processor 602 during execution thereof by the computer system 600. The main memory 604 and the processor 602 also may constitute machine-readable media.

Dedicated hardware implementations including, but not limited to, application specific integrated circuits, programmable logic arrays and other hardware devices can likewise be constructed to implement the methods described herein. Applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example system is applicable to software, firmware, and hardware implementations.

In accordance with various embodiments of the present disclosure, the methods described herein are intended for operation as software programs running on a computer processor. Furthermore, software implementations can include, but not limited to, distributed processing or component/object distributed processing, parallel processing, or virtual machine processing can also be constructed to implement the methods described herein.

The present disclosure contemplates a machine readable medium containing instructions 624, or that which receives and executes instructions 624 from a propagated signal so that a device connected to a network environment 626 can send or receive voice, video or data, and to communicate over the network 626 using the instructions 624. The instructions 624 may further be transmitted or received over a network 626 via the network interface device 620.

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present disclosure. The terms “program,” “software application,” and the like as used herein, are defined as a sequence of instructions designed for execution on a computer system. A program, computer program, or software application may include a subroutine, a function, a procedure, an object method, an object implementation, an executable application, an applet, a servlet, a source code, an object code, a shared library/dynamic load library and/or other sequence of instructions designed for execution on a computer system.

It will be appreciated that embodiments of the invention described herein may be comprised of one or more conventional processors and unique stored program instructions that control the one or more processors to implement, in conjunction with certain non-processor circuits, some, most, or all of the functions of the embodiments of the invention described herein. The non-processor circuits may include, but are not limited to, a radio receiver, a radio transmitter, signal drivers, clock circuits, power source circuits, and user input devices. As such, these functions may be interpreted as steps of a method to facilitate access to a mobile server. Alternatively, some or all functions could be implemented by a state machine that has no stored program instructions, or in one or more application specific integrated circuits (ASICs), in which each function or some combinations of certain of the functions are implemented as custom logic. Of course, a combination of these approaches could be used. Thus, methods and means for these functions have been described herein. In those situations for which functions of the embodiments of the invention can be implemented using a processor and stored program instructions, it will be appreciated that one means for implementing such functions is the media that stores the stored program instructions, be it magnetic storage or a signal conveying a file. Further, it is expected that one of ordinary skill, notwithstanding possibly significant effort and many design choices motivated by, for example, available time, current technology, and economic considerations, when guided by the concepts and principles disclosed herein will be readily capable of generating such stored program instructions and ICs with minimal experimentation.

In the foregoing specification, specific embodiments of the present invention have been described. However, one of ordinary skill in the art appreciates that various modifications and changes can be made without departing from the scope of the present invention as set forth in the claims below. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

In light of the foregoing description, it should also be recognized that embodiments in accordance with the present invention can be realized in numerous configurations contemplated to be within the scope and spirit of the claims. Additionally, the description above is intended by way of example only and is not intended to limit the present invention in any way, except as set forth in the following claims.

What is claimed is:

1. A proxy server for communication with a mobile server, comprising:
a controller, wherein the controller is programmed to:
receive requests for access to the mobile server from a client device;
request a status of the mobile server from a mobile server database;
send a connection request to the mobile server upon determining availability of the mobile server from the mobile server database;
establish a communication link with the mobile server; and
relay information from the mobile server to the client.

2. The proxy server of claim 1, wherein the controller is further programmed to check if the mobile server is already connected to the proxy server.

3. The proxy server of claim 2, wherein the controller is further programmed enable transmission of a short messaging service trigger message to the mobile server.

4. The proxy server of claim 1, wherein the controller is further programmed to look-up a phone-number or address for the mobile server and request a short messaging service (SMS) trigger message from an SMS-PUSH server.

5. The proxy server of claim 1, wherein the controller is further programmed to establish the communication link by registering the IP address of the mobile server.

6. The proxy server of claim 1, wherein the controller is further programmed to establish the communication link by receiving at least an HTTP request and sending at least an HTTP response.

7. The proxy server of claim 6, wherein the controller is further programmed to relay information by sending the HTTP response to the client.

8. The proxy server of claim 1, wherein the controller is programmed to relay requests and responses to and from clients when the mobile server has an online status and further programmed to send cached content to clients when the mobile server has an offline status.

9. The proxy server of claim 1, wherein the proxy server further comprises a search engine operatively coupled thereto for providing the client with a mobile server search service using status information of the mobile server, wherein such status information includes location and temporal information.

10. A mobile server, comprising:
a transceiver;
a controller coupled to the transceiver, wherein the controller is programmed to:
receive a request for access to the mobile server;
transmit a registration of an IP address and status information to a proxy server;
wherein the status information comprises location information and time availability information searchable by a search engine operatively coupled to the proxy server.

11. The mobile server of claim 10, wherein the controller is further programmed to stream content and status information upon establishing a connection to a client via the proxy server.

12. The mobile server of claim 10, wherein the controller is further programmed to transmit status information to the proxy server if the mobile server goes offline and becomes online once again.

13. A method of facilitating access to a mobile server by a client, comprising the steps of:
enabling the search and selection of mobile servers using status information among an availability, a location, or a time frame criteria;
enabling access to a selected mobile server via a proxy server;
providing live streamed content to the client from the mobile server if the mobile server is currently available; and
providing cached content to the client previously stored from the mobile server on a storage medium operatively coupled to the proxy server if the mobile server is currently offline.

14. The method of claim 13, wherein the method further comprises the step of storing the status information from the mobile server at a mobile server status database operatively coupled to the proxy server.

15. The method of claim 14, wherein the mobile server status database further stores URLs, IP addresses, and telephone numbers for the mobile server.

16. The method of claim 13, wherein the availability criteria is an online or offline status of a selected mobile server, the location criteria is GPS position coordinates or other location equivalent provided by the selected mobile server to the proxy server, and the time frame criteria is a time frame when the selected server is currently, will be or was online.

17. The method of claim 13, wherein the method further comprises the step of relaying request and responses to and from the client and a selected mobile server.

18. The method of claim 13, wherein the method further comprises the step of instructing a short messaging service (SMS)-push server to send an SMS message to trigger the mobile server to communicate with the proxy server.

19. The method of claim 13, wherein the method further comprises the step of caching the streamed contents from the mobile server on a storage medium operatively coupled to the proxy server for the time the mobile server is offline.

20. A computer-readable storage medium operating in one or more network devices, comprising computer instructions for:
enabling the search and selection of mobile servers using status information among an availability, a location, or a time frame criteria;
accessing a selected mobile server via a proxy server;
streaming content to a client from the mobile server if the mobile server is currently available; and
streaming cached content to the client previously stored from the mobile server on a storage medium operatively coupled to the proxy server if the mobile server is currently offline.
